(19) United States
(12) Patent Application Publication
(10) Pub. No.: US 2009/0324240 A1
(43) Pub. Date: Dec. 31, 2009

(54) TRANSMISSION LINE OPTIMIZATION METHOD IN OPTICAL COMMUNICATION SYSTEM

(76) Inventor: MAKOTO ISHIGURO, Tokyo (JP)

Correspondence Address: Jackson Chen;NEC Corporation of America, 6535 N. State Hwy. 161, Irving, TX, 75039, US

(21) Appl. No.: 12/493,564

(22) Filed: Jun. 29, 2009

(30) Foreign Application Priority Data
Jun. 30, 2008 (JP) 2008-170040

(51) Int. Cl. H04B 10/12; H04B 10/00

(52) U.S. Cl. 398/141; 398/173

(57) ABSTRACT

In an optical communication system in which an optical signal is sequentially transferred through a plurality of transmission sections of an entire transmission line between a most upstream node and a most downstream node, wherein the entire transmission line is sectioned by at least one intermediate node into the transmission sections, a transmission line optimization method includes: concurrently transmitting a test signal from an upstream node of each transmission section to a downstream node thereof, causing each downstream node to perform individual optimization of a corresponding transmission section in parallel; sequentially transmitting a first signal indicating completion of upstream individual optimization in a downstream direction from a most upstream immediate node to most downstream node through immediate nodes which has completed the individual optimization; and transmitting a second signal indicating completion of entire optimization in an upstream direction from the most downstream node to the most upstream node.

### BACKGROUND OF THE INVENTION

This application is based upon and claims the benefit of priority from Japanese Patent Application No. 2008-170040, filed on Jun. 30, 2008, the disclosure of which is incorporated herein in its entirety by reference.

1. Field of the Invention

The present invention relates to an optical communication system in which an optical signal is sequentially transmitted through a plurality of transmission sections of an entire transmission line and, more particularly, to a transmission line optimization method for entire optimization of the transmission lines in the optical communication system.

2. Description of the Related Art

In an optical communication system, long-distance communication is made feasible generally in such a manner that optical repeaters are inserted into an optical transmission line and further that dispersion in the optical fiber is compensated by a dispersion compensator or dispersion equalizer. Such a general optical communication system and dispersion compensation method will be described briefly.

FIG. 1A is a block diagram showing a schematic network structure of a general optical communication system, and FIG. 1B is a graph showing the range of dispersion compensation setting. Referring to FIG. 1A, it is assumed that a repeater 21 is installed between a long-distance optical communication transceiver 20 connected to an optical transmitter 10 and a long-distance optical communication transceiver 22 connected to an optical receiver 11.

The long-distance optical communication transceiver 20 and the repeater 21 are connected through optical fiber (transmission line) 30, and optimization of the optical fiber 30 is performed by a dispersion compensator 31 of the repeater 21. Similarly, the repeater 21 and the long-distance optical communication transceiver 22 are connected through optical fiber (transmission line) 40, and optimization of the optical fiber 40 is performed by a dispersion compensator 41 of the long-distance optical communication transceiver 22.

Setting for optimization of a dispersion compensation value for the optical fiber is made as follows. As shown in FIG. 1B as an example, the number of signal errors (hereinafter, a signal error rate) varies with the dispersion compensation value. Therefore, the dispersion compensation value is set at such a value that the signal error rate becomes the smallest. For example, while varying the dispersion compensation value to be set on the dispersion compensator from a value A to a value B, the signal error rate is measured between these values. Then, the dispersion compensation value is set at a value E where the signal error rate is the smallest. However, if it is sufficient to set the signal error rate to be 10-12 or smaller, the dispersion compensation value can be any value between values C and D.

For example, Japanese Patent Application Unexamined Publication No. 2000-115077 discloses a system in which longer-distance optical communication is accomplished by performing optical fiber dispersion compensation on each transmission section. According to this system, a dispersion compensator is provided for each of transmission lines sectioned by repeaters, and an acknowledgment, ACK, indicative of completion of dispersion compensation is transmitted to the next stage, whereby dispersion compensation is sequentially performed at respective ones of the repeaters.

However, since the optimization of dispersion compensation for optical fiber is performed while varying the dispersion compensation value as shown in FIG. 1B, some time is required. Accordingly, in a communication system in which not only two transmission sections as shown in FIG. 1A but a large number of transmission sections are contiguous; much time is required to sequentially perform dispersion compensation from upstream to downstream.

For example, in the transmission system shown in FIG. 1A, to optimize the value set on the dispersion compensator 31, it is necessary to search for the optimum point while varying the dispersion compensation value as shown in FIG. 1B. During this search time, errors propagate downstream. Accordingly, to optimize the value set on the downstream dispersion compensator 41, it is necessary that the optimization of the value set on the upstream dispersion compensator 31 has been completed. Therefore, when there are N transmission sections, time for N sections is required to optimize the values set on the dispersion compensators for all the transmission sections between the most upstream node and the most downstream node.

### SUMMARY OF THE INVENTION

Accordingly, an object of the present invention is to provide a transmission line optimization method in an optical communication system, which can reduce the time required to optimize an entire transmission line sectioned into a plurality of transmission sections, as well as an optical transmitter, an optical receiver, and an optical repeater used in the system.

According to the present invention, a transmission line optimization method in an optical communication system in which an optical signal is sequentially transferred through a plurality of transmission sections of an entire transmission line between a most upstream node and a most downstream node, wherein the entire transmission line is sectioned by at least one intermediate node into the transmission sections, includes: concurrently transmitting a test signal from an upstream node of each transmission section to a downstream node thereof, causing each downstream node to perform individual optimization of a corresponding transmission section in parallel; sequentially transmitting a first signal indicating completion of upstream individual optimization in a downstream direction from a most upstream immediate node to most downstream node through immediate nodes which has completed the individual optimization; and transmitting a second signal indicating completion of entire optimization in an upstream direction from the most downstream node to the most upstream node.

According to the present invention, an optical communication system in which an optical signal is sequentially transferred through a plurality of transmission sections of an entire transmission line between a most upstream node and a most downstream node, wherein the entire transmission line is sectioned by at least one intermediate node into the transmission sections, wherein an upstream node of each transmission section concurrently transmits a test signal from to a downstream node thereof, wherein downstream nodes perform individual optimization of corresponding transmission sections in parallel, respectively; immediate nodes each having completed the individual optimization sequentially transmits a first signal indicating completion of upstream individual optimization in a downstream direction; and the most downstream node and the immediate nodes sequentially transmit a second signal indicating completion of entire optimization in an upstream direction.

According to the present invention, transmission line optimization is performed for a plurality of transmission sections of an entire transmission line individually but concurrently in parallel, whereby it is possible to reduce the time required to optimize the entire transmission line.

### BRIEF DESCRIPTION OF THE DRAWINGS

FIG. 1A is a block diagram showing a schematic network structure of a general optical communication system.

FIG. 1B is a graph for describing the range of dispersion compensation setting.

FIG. 2 is a sequence diagram for describing operation for transmission line optimization in an optical communication system according to an exemplary embodiment of the present invention.

FIG. 3 is a block diagram showing a schematic configuration of a most upstream node in an optical communication system according to a first example of the present invention.

FIG. 4 is a block diagram showing a schematic configuration of a repeater node in the optical communication system according to the first example of the present invention.

FIG. 5 is a block diagram showing a schematic configuration of a most downstream node in the optical communication system according to the first example of the present invention.

FIG. 6 is a sequence diagram for describing operation for transmission line optimization in an optical communication system according to a second example of the present invention.

FIG. 7 is a sequence diagram for describing operation for transmission line optimization in an optical communication system according to a third example of the present invention.

### DETAILED DESCRIPTION OF THE PREFERRED EMBODIMENTS

### 1. EXEMPLARY EMBODIMENT

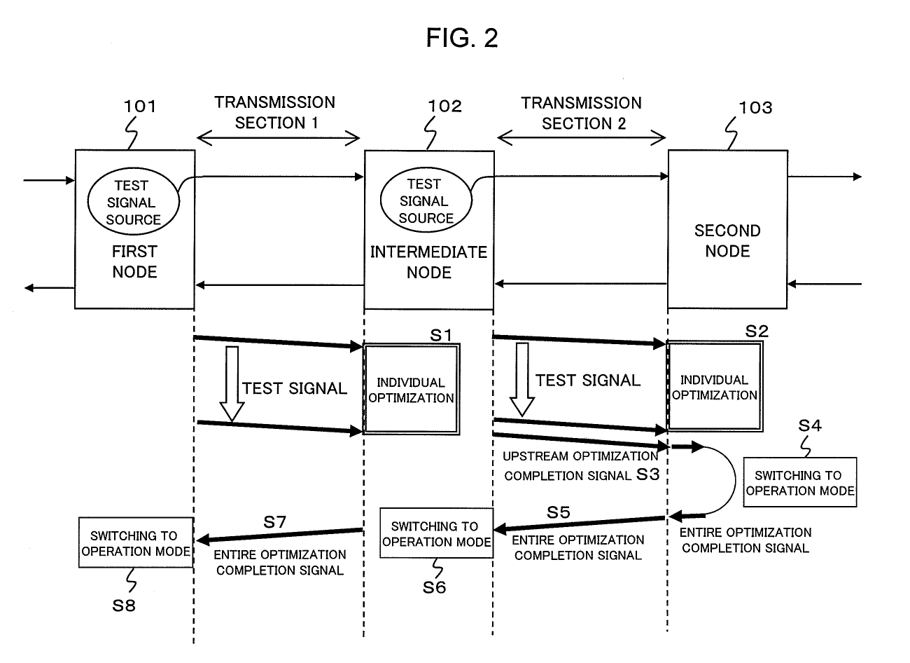

FIG. 2 is a sequence diagram for describing operation for transmission line optimization in an optical communication system according to an exemplary embodiment of the present invention. Here, to avoid complicating the description, it is assumed that one intermediate node 102 is intermediate between a first node 101 that is the most upstream node and a second node 103 that is the most downstream node. Even if a plurality of repeater nodes 102 are connected as intermediated nodes, the basic operation for transmission line optimization is similar, which will be described later.

A transmission section 1 between the first node 101 and the intermediate node 102 and a transmission section 2 between the intermediate node 102 and the second node 103 are part of an entire transmission line from the first node 101 to the second node 103, and it is also assumed that two-way communication are possible. Here, the node on the downstream side of a signal being transmitted over a transmission section is a node corresponding to the transmission section in question and performs individual optimization processing for the transmission section in question. Each of the first node 101, intermediate node 102, and second node 103 has a test mode and an operation mode. Switching from the test mode to the operation mode is made automatically, which will be described later. A procedure of transmission line optimization in the test mode is as follows.

First, the first node 101 and the intermediate node 102, in unison, transmit test signals onto the transmission sections 1 and 2, respectively. The intermediate node 102 corresponding to the transmission section 1, while continuing to receive the test signal from the first node 101, performs individual optimization processing for the transmission section 1 (Step S1). At the same time, the second node 103 corresponding to the transmission section 2, while continuing to receive the test signal from the intermediate node 102, performs individual optimization processing for the transmission section 2 (Step S2). Such individual optimization processing by each node can be concurrently performed in parallel, for example, at a command from a system management device or by user setting. However, the individual optimization processing does not need to be performed strictly at the same time, which will be described later.

The individual optimization processing is, for example, processing of optimizing the dispersion compensation value for the optical fiber of each transmission section, as described earlier. Besides this, it is also possible to perform the individual optimization by using information on bit rate abnormality, signal level abnormality, and the like.

Upon completion of the individual optimization processing S1, the intermediate node 102 transmits an upstream optimization completion signal to the downstream second node 103 (Step S3). The upstream optimization completion signal is a signal indicating that individual optimization has been completed by each node located upstream of a node receiving this signal. Accordingly, for a node to transmit an upstream optimization completion signal to a downstream node, it is necessary that this node have received an upstream optimization signal indicating that individual optimization has been completed by every node located upstream of this node, and also have completed its own individual optimization processing. In the present exemplary embodiment, since the intermediate node 102 corresponds to the most upstream transmission section 1, the intermediate node 102 receives no upstream optimization completion signal from an upstream node and therefore, when individual optimization is completed by the intermediate node 102, transmits an upstream optimization completion signal to the downstream second node 103.

On the other hand, since the second node 103 is a node located at the end of the entire transmission line, the second node 103 receives an upstream optimization completion signal from the upstream intermediate node 102 but does not need to transmit an upstream optimization completion signal to a downstream node. When such a most downstream second node 103 has completed its own individual optimization processing (Step S2) and also has received the upstream optimization completion signal indicating that individual optimization has been completed by every node located upstream of the second node 103 (Step S3), then the second node 103 switches the mode of its own node from the test mode to the operation mode (Step S4), generates an entire optimization completion signal, and transmits the entire optimization completion signal back toward upstream (Step S5). Accordingly, even if the second node 103 has completed its own individual optimization processing S2 earlier, the second node 103 does not switch modes or transmit the entire optimization completion signal until the second node 103 has received the upstream optimization completion signal from upstream. Reversely, even if the second node 103 has received the upstream optimization completion signal from upstream before completing its own optimization processing, the second node 103 does not switch modes or transmit the entire optimization completion signal until the second node 103 has completed its own optimization processing.

The entire optimization completion signal is a signal indicating that optimization has been completed by all of the nodes, from the most upstream node to the most downstream node. At each node having received this signal, the mode is switched automatically from the test mode to the operation mode. At the intermediate node 102 having received the entire optimization completion signal from the second node 103, the mode is switched from the test mode to the operation mode (Step S6), and the intermediate node 102 transmits the same entire optimization completion signal to the further upstream first node 101 (Step S7). At the first node 101 having received the entire optimization completion signal from the intermediate node 102, the mode is switched from the test mode to the operation mode (Step S8). In this manner, the entire optimization completion signal is sequentially transmitted, whereby all the nodes are switched to the operation mode substantially at the same time, thus making it possible to transmit a main signal.

As described above, according to the present exemplary embodiment, optimization of each transmission section is concurrently performed in unison, and it is notified to all the nodes that the optimization has been completed for all the transmission sections, whereby it is possible to automatically switch all the nodes from the test mode to the operation mode. More specifically, each node concurrently performs optimization of its corresponding transmission section so that optimization of all the transmission sections is performed in parallel. Each node then sequentially transmits an upstream optimization completion signal, thereby sequentially recognizing the transmission sections of which optimization has been completed. Then, an entire optimization completion signal is sequentially transferred to all the nodes, starting from the node on the end of the entire transmission line. Thus, it is possible to complete transmission line optimization in the entire system in a short time.

Moreover, even when transmission distance is extended, optimization of the entire transmission line can be automatically performed through the above-described procedure, only by adding a repeater node or repeater nodes. Accordingly, it is possible to enhance the flexibility and extensibility of the system.

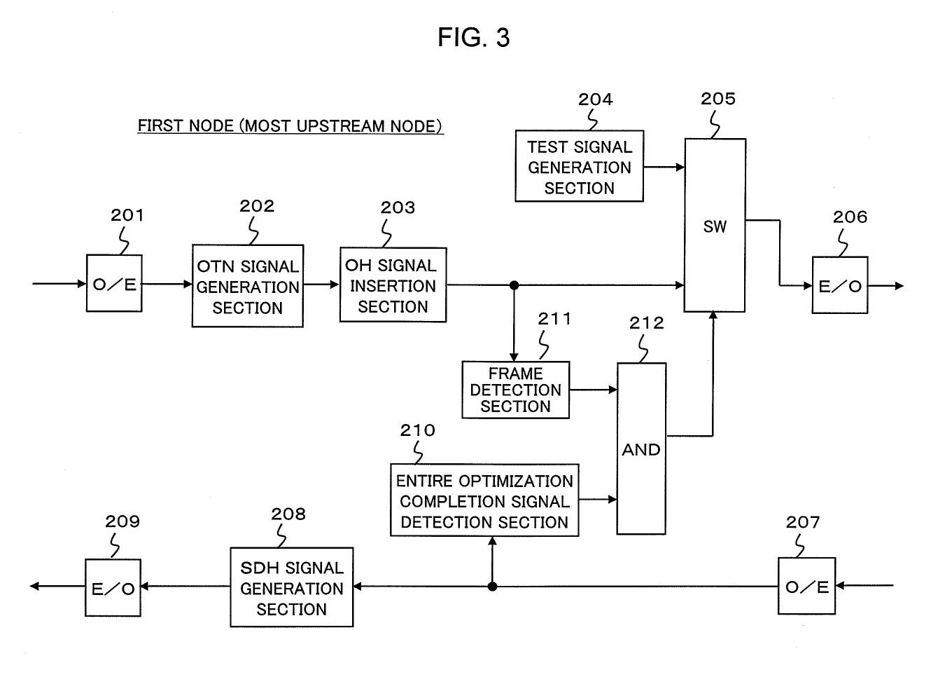

Hereinafter, specific examples of the optical communication system according to the present exemplary embodiment will be described in more detail with reference to FIGS. 3 to 5.

### 2. FIRST EXAMPLE

### 2.1) MOST UPSTREAM NODE (FIRST NODE)

FIG. 3 is a block diagram showing a schematic configuration of a most upstream node in an optical communication system according to a first example of the present invention. Here, only the components required for the most upstream node according to the present example are shown for simplicity. This most upstream node corresponds to the first node 101 in FIG. 2.

Referring to FIG. 3, a transmitting system of the most upstream node includes an optical-to-electrical signal conversion section (O/E) 201, an OTN signal generation section 202, an OH signal insertion section 203, a test signal generation section 204, a switch section 205, and an electrical-to-optical signal conversion section (E/O) 206. Moreover, a receiving system of the most upstream node includes an O/E 207, a SDH signal generation section 208, and an E/O 209. A control system of the most upstream node includes an entire optimization completion signal detection section 210, a frame detection section 211, and an AND circuit 212 and performs switching control of the switch section 205 based on the AND (logical product) of a detection signal from the entire optimization completion signal detection section 210 and a detection signal from the frame detection section 211.

The O/E 201 receives as input an optical signal (here, a synchronous digital hierarchy (SDH) signal) having an optical level and a wavelength conforming to the specifications of an optical transceiver (not shown), converts the optical SDH signal into an electrical SDH signal, and outputs the electrical SDH signal to the OTN signal generation section 202. The OTN signal generation section 202 maps the electrical SDH signal into an optical transport network (OTN) signal. Here, the OTN signal is a signal format prescribed by ITU-T G. 907. The OH signal insertion section 203 inserts an overhead (OH) signal into the OTN signal and outputs the resulting signal to the switch section 205. As will be described later, the OTN signal includes an empty byte, in which an upstream optimization completion signal and an entire optimization completion signal according to the present example can be defined.

In the test mode, the switch section 205 outputs a test signal from the test signal generation section 204 to the E/O 206. In the operation mode, the switch section 205 outputs to the E/O 206 an OTN signal, which is a main signal. Switching from the test mode to the operation mode depends on an output from the AND circuit 212.

The frame detection section 211 outputs a detection signal when a frame is normally detected from an OTN signal to be transmitted. The entire optimization completion signal detection section 210 outputs a detection signal when receipt of an entire optimization completion signal is detected. Accordingly, only when an OTN signal is output normally and also an entire optimization completion signal is received, a switching signal is output from the AND circuit 212 to the switch section 205, and switching from the test mode to the operation mode is performed.

### 2.2) REPEATER NODE (INTERMEDIATE NODE)

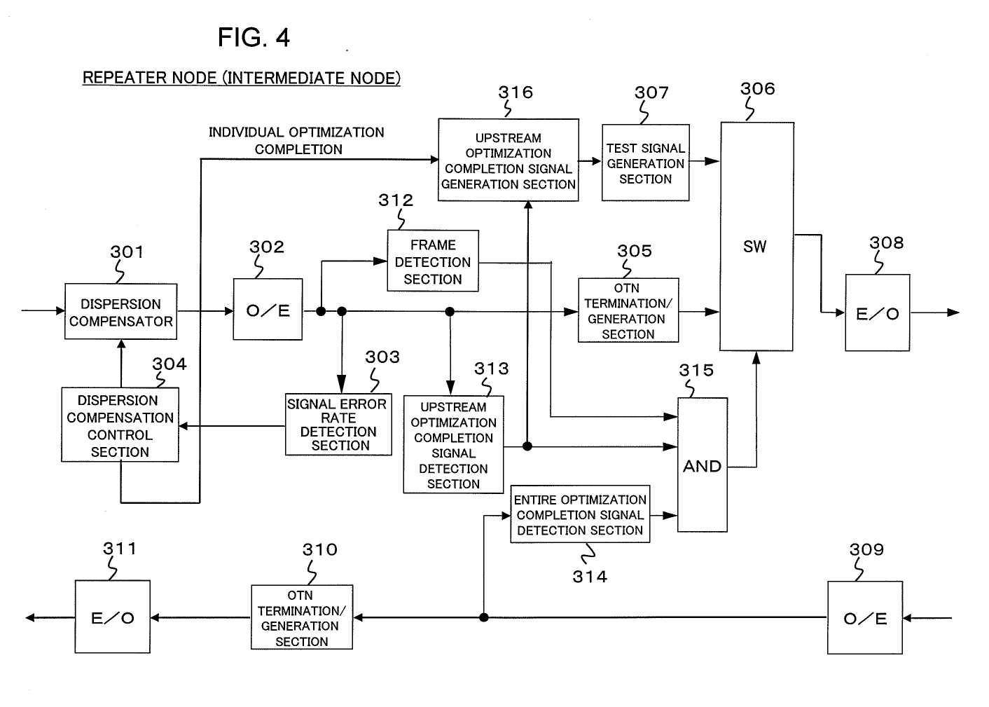

FIG. 4 is a block diagram showing a schematic configuration of a repeater node in the optical communication system according to the first example of the present invention. Here, only the components required for the repeater node according the present example are shown for simplicity. This repeater node corresponds to the intermediate node 102 in FIG. 2.

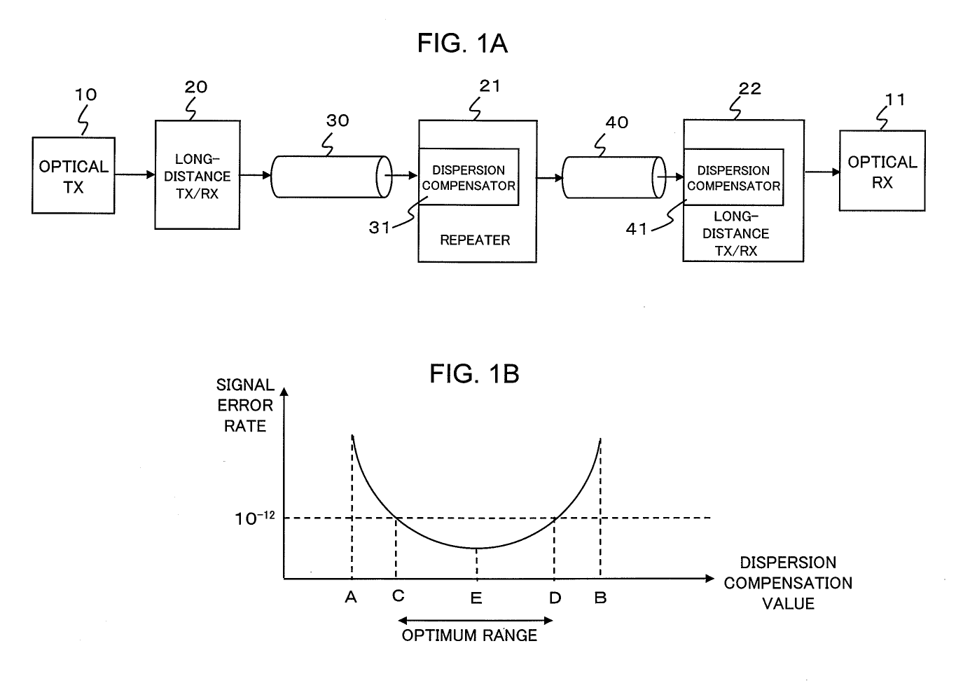

Referring to FIG. 4, an optical OTN signal received from an upstream node is converted into an electrical signal by an O/E 302 after optical fiber dispersion is compensated by a dispersion compensator 301. The dispersion compensation control is performed based on a signal error rate detected from the electrical OTN signal by a signal error rate detection section 303. Specifically, a dispersion compensation control section 304 varies the dispersion compensation value set on the dispersion compensator 301 while monitoring the signal error rate and sets the dispersion compensation value at a value where the signal error rate is the smallest as shown in FIG. 1B, whereby individual optimization is completed.

Moreover, the electrical OTN signal output from the O/E 302 is OTN-terminated by an OTN termination/generation section 305, and then an OTN signal is generated again and output to a switch section 306. The switch section 306 outputs a test signal input from a test signal generation section 307 to an E/O 308 in the test mode but outputs an OTN signal input from the OTN termination/generation section 305 to the O/E 308 in the operation mode. Switching from the test mode to the operation mode depends on an output from an AND circuit 315 of a control system, which will be described later.

An optical OTN signal received from a downstream node is converted into an electrical signal by an O/E 309 and output to an OTN termination/generation section 310. The OTN termination/generation section 310 OTN-terminates the electrical OTN signal and then generates an OTN signal again. This generated OTN signal is converted into an optical OTN signal by an E/O 311 and then transmitted to an upstream node.

The control system includes a frame detection section 312, an upstream optimization completion signal detection section 313, an entire optimization completion signal detection section 314, the AND circuit 315, and an upstream optimization completion signal generation section 316. The frame detection section 312 outputs a detection signal to the AND circuit 315 when a frame is normally detected from an electrical OTN signal output from the O/E 302. The upstream optimization completion signal detection section 313 outputs a detection signal to each of the AND circuit 315 and the upstream optimization completion signal generation section 316 when an upstream optimization completion signal is detected from an electrical OTN signal output from the O/E 302. The entire optimization completion signal detection section 314 outputs a detection signal to the AND circuit 315 when an entire optimization completion signal is received from a downstream node. Accordingly, only when an electrical OTN signal is normal, an upstream optimization completion signal is received from upstream, and also an entire optimization completion signal is received, a switching control signal is output from the AND circuit 315 to the switch section 306, and switching from the test mode to the operation mode is performed.

The upstream optimization completion signal generation section 316 receives as input a notification of completion of individual optimization from the dispersion compensation control section 304 and also receives as input a detection signal from the upstream optimization completion signal detection section 313. Then, only when individual optimization has been completed by its own node and also an upstream optimization completion signal has been received from upstream, the upstream optimization completion signal generation section 316 generates an upstream optimization completion signal and transmits it to a downstream node via the test signal generation section 307, switch section 306, and E/O 308.

### 2.3) MOST DOWNSTREAM NODE (SECOND NODE)

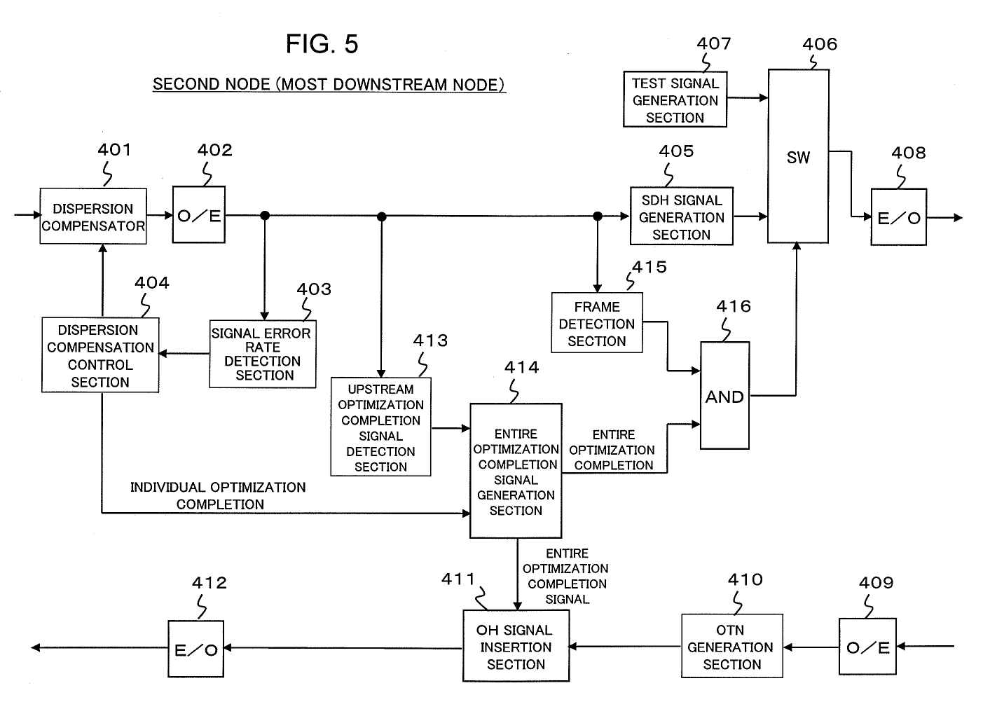

FIG. 5 is a block diagram showing a schematic configuration of a most downstream node in the optical communication system according to the first example of the present invention. Here, only the components required for the most downstream node according to the present example are shown for simplicity. This most downstream node corresponds to the second node 103 in FIG. 2.

Referring to FIG. 5, an optical OTN signal received from an upstream node is converted into an electrical signal by an O/E 402 after optical fiber dispersion is compensated by a dispersion compensator 401. The dispersion compensation control is performed based on a signal error rate detected from the electrical OTN signal by a signal error rate detection section 403. Specifically, a dispersion compensation control section 404 varies the dispersion compensation value set on the dispersion compensator 401 while monitoring the signal error rate and sets the dispersion compensation value at a value where the signal error rate is the smallest as shown in FIG. 1B, whereby individual optimization is completed.

Moreover, a SDH signal generation section 405 receives as input an electrical OTN signal output from the O/E 402, generates a SDH signal, and outputs the SDH signal to a switch section 406. The switch section 406 outputs a test signal from a test signal generation section 407 to an E/O 408 in the test mode but outputs a SDH signal input from the SDH signal generation section 405 to the O/E 408 in the operation mode. Switching from the test mode to the operation mode depends on an output from an AND circuit 416 of a control system, which will be described later.

An optical OTN signal received from an optical transceiver (not shown) is converted into an electrical signal by an O/E 409, and an electrical OTN signal is generated by an OTN signal generation section 410 and then output to an OH signal insertion section 411. The OH signal insertion section 411 writes an entire optimization completion signal onto a predetermined empty byte of the OTN signal. This OTN signal with the entire optimization completion signal written thereon is converted into an optical OTN signal by an E/O 412 and then transmitted to an upstream node.

The control system includes an upstream optimization completion signal detection section 413, an entire optimization completion signal generation section 414, a frame detection section 415, and the AND circuit 416. The upstream optimization completion signal detection section 413 outputs a detection signal to the entire optimization completion signal generation section 414 when an upstream optimization completion signal is detected from an electrical OTN signal output from the O/E 402. Upon receipt of both of a notification of completion of individual optimization input from the dispersion compensation control section 404 and a detection signal input from the upstream optimization completion signal detection section 413, the entire optimization completion signal generation section 414 outputs an entire optimization completion signal as a notification of completion of entire optimization to the AND circuit 416. The frame detection section 415 outputs a detection signal to the AND circuit 416 when a frame is normally detected from an electrical OTN signal output from the O/E 402. Accordingly, only when a received electrical OTN signal is normal, an upstream optimization completion signal has been received from upstream, and also individual optimization has been completed by its own node, a switching control signal is output from the AND circuit 416 to the switch section 406, and switching from the test mode to the operation mode is performed.

### 2.4) EFFECTS

As described above, according to the first example, the repeater node and the most downstream node concurrently perform individual optimization of their respective transmission sections. Then, a node that has completed its own individual optimization processing sequentially transmits an upstream optimization completion signal to downstream, whereby each node can sequentially recognize the transmission sections of which optimization has been completed. Moreover, an entire optimization completion signal is sequentially transferred from the most downstream node to all the upstream nodes, whereby optimization of the entire transmission line in the optical communication system can be completed in a short time. Furthermore, even when transmission distance is extended, optimization of the entire transmission line can be automatically performed only by adding a repeater node or repeater nodes. Accordingly, it is possible to enhance the flexibility and extensibility of the system.

### 3. SECOND EXAMPLE

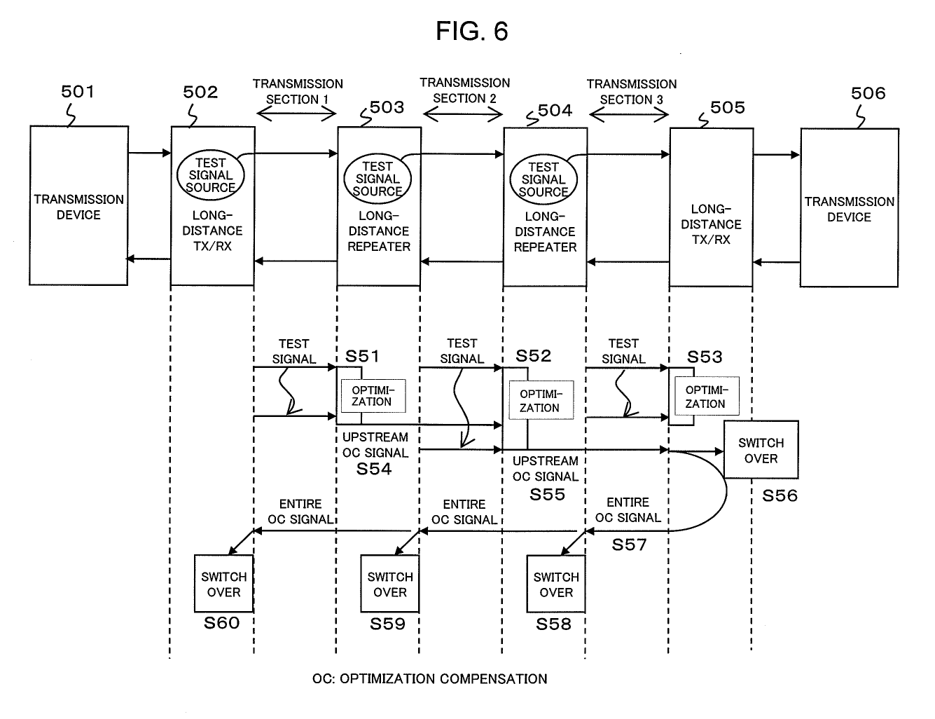

FIG. 6 is a sequence diagram for describing operation for transmission line optimization in an optical communication system according to a second example of the present invention. Shown here, as an example, is a system in which repeaters 503 and 504 for long-distance optical communication are provided between an optical transceiver 502 connected to a transmission device 501 and an optical transceiver 505 connected to a transmission device 506. It is assumed that individual optimization processing using a test signal is performed for each of transmission sections 1, 2, and 3, which are part of an entire optical transmission line between the optical transceiver 502 and the optical transceiver 506. Moreover, it is assumed that the optical transceiver 502 has the block configuration of the most upstream node shown in FIG. 3, that the repeaters 503 and 504 each have the block configuration of the repeater node shown in FIG. 4, and that the optical transceiver 505 has the block configuration of the most downstream node shown in FIG. 5.

First, the optical transceiver 502 and the repeaters 503 and 504, in unison, transmit test signals onto the transmission sections 1, 2, and 3, respectively. The repeater 503 corresponding to the transmission section 1, while continuing to receive the test signal from the optical transceiver 502, performs individual optimization processing for the transmission section 1 (Step S51). At the same time, the repeater 504 corresponding to the transmission section 2 performs individual optimization processing for the transmission section 2 while continuing to receive the test signal from the repeater 503 (Step S52), and the optical transceiver 505 corresponding to the transmission section 3 performs individual optimization processing for the transmission section 3 while continuing to receive the test signal from the repeater 504 (Step S53).

Upon completion of its own individual optimization processing S51, the repeater 503 transmits an upstream optimization completion signal to the downstream repeater 504 (Step S54). Note that “optimization completion” is abbreviated as “OC” in FIG. 6.

Even if the repeater 504 receives the upstream optimization completion signal from the repeater 503 before completion of the individual optimization processing S52, the repeater 504 does not transmit an upstream optimization completion signal until its own individual optimization processing S52 is completed as described earlier (see the operation of the upstream optimization completion signal generation section 316 of the repeater node shown in FIG. 4). When the repeater 504 has received the upstream optimization completion signal from the upstream repeater 503 and also has completed its own individual optimization processing, then the upstream optimization completion signal generation section 316 generates an upstream optimization completion signal and transmits it to the downstream optical transceiver 505 (Step S55).

The optical transceiver 505, which is located most downstream, does not generate an upstream optimization completion signal even when the optical transceiver 505 has completed its own individual optimization processing. This is because, as described earlier, the optical transceiver 505 generates an entire optimization completion signal when the optical transceiver 505 has completed its own individual optimization processing and also has received the upstream optimization completion signal from the upstream repeater 504 (see the operation of the entire optimization completion signal generation section 414 of the most downstream node shown in FIG. 5). Here, when the optical transceiver 505 has received the upstream optimization completion signal from the upstream repeater 504, the switch section 406 is switched so that a SDH signal will be output to the transmission device 506 (Step S56), and an entire optimization completion signal is transmitted toward upstream (Step S57).

When the entire optimization completion signal detection section 314 of the repeater 504 has detected receipt of the entire optimization completion signal, since the upstream optimization completion signal has been already detected, the switch section 306 is switched so that an OTN signal will be output to the optical transceiver 505 (Step S58), and the entire optimization completion signal is transferred toward upstream further. At the repeater 503 as well, the switch section 306 is similarly switched (Step S59), and the entire optimization completion signal is transferred toward upstream further. Finally, when the entire optimization completion signal detection section 210 of the most upstream optical transceiver 502 has detected receipt of the entire optimization completion signal, the switch section 205 is switched so that an OTN signal will be output to the repeater 503 (Step S60). The entire optimization completion signal is transmitted in this manner, whereby all the nodes switch transmission signals substantially at the same time, thus making it possible to transmit a main signal.

### 4. THIRD EXAMPLE

In the above-described first and second examples, transmission line optimization is shown with respect to one-way transmission. However, the present invention can be similarly applied in cases of two-way transmission.

Specifically, the receiving system of the most downstream node shown in FIG. 5 is adopted for the receiving system of the most upstream node shown in FIG. 3. Moreover, the configuration in one of the directions of the repeater node shown in FIG. 4 (the blocks at reference numerals 301 to 308) is adopted in the other direction. Furthermore, the transmitting system of the most upstream node shown in FIG. 3 is adopted for the transmitting system of the most downstream node shown in FIG. 5. Since the basic configurations and operation, both in the upstream direction and in the downstream direction, are similar to those described in first and second examples, a detailed description thereof will be omitted.

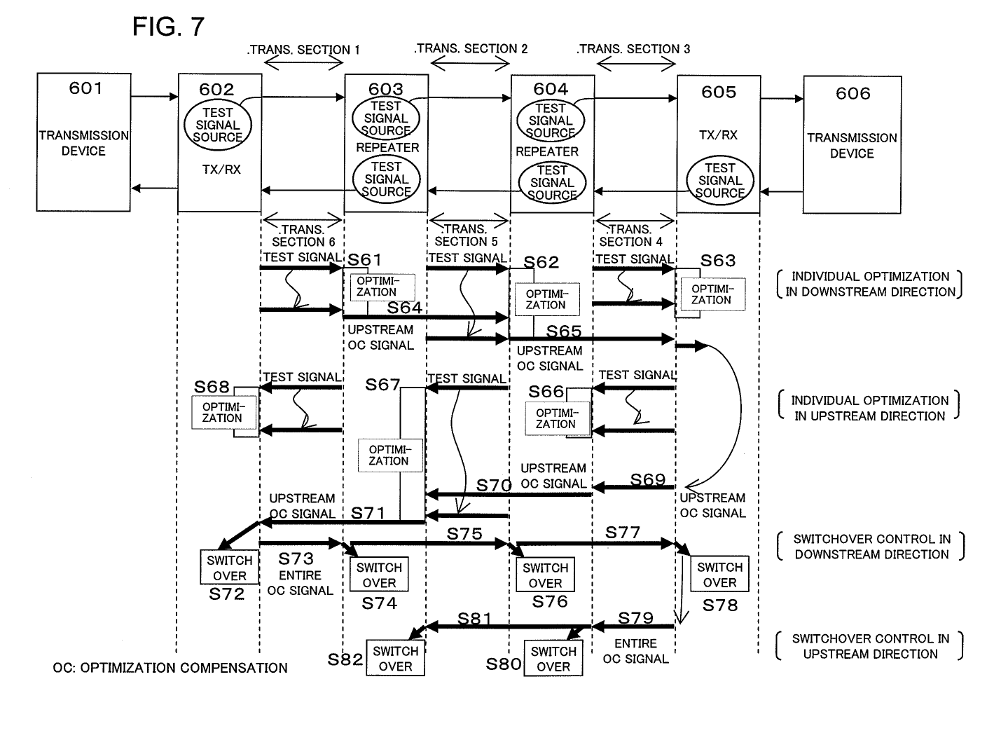

FIG. 7 is a sequence diagram for describing operation for transmission line optimization in an optical communication system according to a third example of the present invention. Shown here, as an example, is a system in which repeaters 603 and 604 for long-distance optical communication are provided between an optical transceiver 602 connected to a transmission device 601 and an optical transceiver 605 connected to a transmission device 606. It is assumed that individual optimization processing using a test signal is performed for each of transmission sections 1, 2, and 3 for one direction and each of transmission sections 4, 5, and 6 for the opposite direction, which are part of two optical transmission lines, respectively.

Moreover, it is assumed that the transmitting system of the optical transceiver 602 has the block configuration of the most upstream node shown in FIG. 3 and the receiving system thereof has the block configuration of the most downstream node shown in FIG. 5, that each of the respective circuits in both directions of each of the repeaters 603 and 604 has the block configuration of the repeater node shown in FIG. 4 (the blocks at reference numerals 301 to 308), and that the reception system of the optical transceiver 605 has the block configuration of the most downstream node shown in FIG. 5 and the transmission system thereof has the block configuration of the most upstream node shown in FIG. 3.

First, an optimization procedure in the downstream direction is similar to the steps S51 to S55 shown in FIG. 6. Specifically, the optical transceiver 602 and the repeaters 603 and 604, in unison, transmit test signals onto the transmission sections 1 to 3, respectively. The repeater 603 performs individual optimization processing for the transmission section 1 (step S61), the repeater 604 performs individual optimization processing for the transmission section 2 (step S62), and the optical transceiver 605 performs individual optimization processing for the transmission section 3 (step S63). Transmission of an upstream optimization completion signal following this processing (steps S64 and S65) is similarly performed as in the above-described steps S54 and S55 shown in FIG. 6.

The optical transceiver 605 located most downstream starts an optimization procedure in the opposite direction upon receipt of an upstream optimization completion signal from the upstream repeater 604. Specifically, the optical transceiver 605 and the repeaters 604 and 603, in unison, transmit test signals onto the transmission sections 4, 5 and 6, respectively. The repeater 604 performs individual optimization processing for the transmission section 4 (step S66), the repeater 603 performs individual optimization processing for the transmission section 5 (step S67), and the optical transceiver 602 performs individual optimization processing for the transmission section 6 (step S68). Transmission of an upstream optimization completion signal following this processing (steps S69 to S71) is similarly performed as described above. It should be noted that “upstream” of the upstream optimization completion signals in the steps S69-S71 is actually determined with respect to the direction from the optical transceiver 605 to the optical transceiver 602.

When individual optimization of all the transmission sections 1-3 and 4-6 has been completed in both directions in this manner, and when the optical transceiver 602 has received an upstream optimization completion signal from the repeater 603, then the switch sections for both directions each switch to a main signal in both directions (step S72), and the optical transceiver 602 transmits an entire optimization completion signal in the downstream direction (step S73).

The repeater 603 detects receipt of the entire optimization completion signal from upstream with respect to the direction from the optical transceiver 602 to the optical transceiver 605, whereby the switch section for signals from the upstream direction switches to a main signal (step S74), and the entire optimization completion signal is transferred toward downstream further (step S75). Similarly, the repeater 604 also detects receipt of the entire optimization completion signal from upstream, whereby the switch section for signals from the upstream direction switch to a main signal (step S76), and the entire optimization completion signal is transferred toward downstream further (step S77).

When the most downstream optical transceiver 605 has detected receipt of the entire optimization completion signal from upstream, the switch sections for both directions each switch to a main signal (step S78), and the entire optimization completion signal is transmitted back in the upstream direction (step S79).

The repeater 604 detects receipt of the entire optimization completion signal from downstream, whereby the switch section for signals from the downstream direction switches to a main signal (step S80), and the entire optimization completion signal is transferred toward upstream further (step S81). Similarly, the repeater 603 detects receipt of the entire optimization completion signal from downstream, whereby the switch section for signals from the downstream direction switches to a main signal (step S82). In this manner, the entire optimization completion signal travels (goes and returns) between the most upstream node and the most downstream node, whereby all the nodes perform switching of transmission signals substantially concurrently, thus making it possible to transmit a main signal in both directions.

In a manner as described above, optimization of the dispersion compensation value or the like for each transmission section is performed by using a test signal individually but substantially concurrently, and completion of the individual optimization is sequentially notified between nodes, whereby optimization of all transmission sections, that is, the entire two-way transmission lines, can be performed in a short time. Moreover, by using an entire optimization completion signal, it is possible to automatically perform optimization of the entire transmission system including multiple-stage connections.

Note that the functions of each node according to the above-described first to third examples can also be implemented by executing respective programs on a program-controlled computer such as a CPU.

The present invention can be applied to synchronous networks such as SDH/SONET networks.

The present invention may be embodied in other specific forms without departing from the spirit or essential characteristics thereof. The above-described exemplary embodiment and examples are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A transmission line optimization method in an optical communication system in which an optical signal is sequentially transferred through a plurality of transmission sections of an entire transmission line between a most upstream node and a most downstream node, wherein the entire transmission line is sectioned by at least one intermediate node into the transmission sections, comprising:
concurrently transmitting a test signal from an upstream node of each transmission section to a downstream node thereof, causing each downstream node to perform individual optimization of a corresponding transmission section in parallel;
sequentially transmitting a first signal indicating completion of upstream individual optimization in a downstream direction from a most upstream immediate node to most downstream node through immediate nodes which has completed the individual optimization; and
transmitting a second signal indicating completion of entire optimization in an upstream direction from the most downstream node to the most upstream node.

2. The transmission line optimization method according to claim 1, wherein the most upstream immediate node transmits the first signal when having completed its own individual optimization, wherein each intermediate node but the most upstream immediate node transmits the first signal to a corresponding downstream node when having received the first signal from a corresponding upstream node and having completed its own individual optimization.

3. The transmission line optimization method according to claim 2, wherein each node which has received the second signal from a corresponding downstream node automatically switches from a test mode to an operation mode.

4. The transmission line optimization method according to claim 1, wherein the most downstream node automatically switches from a test mode to an operation mode when having received the first signal from a corresponding upstream node and having completed its own individual optimization, wherein each node but the most downstream node which has received the second signal from a corresponding downstream node automatically switches from the test mode to the operation mode.

5. An optical communication system in which an optical signal is sequentially transferred through a plurality of transmission sections of an entire transmission line between a most upstream node and a most downstream node, wherein the entire transmission line is sectioned by at least one intermediate node into the transmission sections, wherein
an upstream node of each transmission section concurrently transmits a test signal from to a downstream node thereof, wherein downstream nodes perform individual optimization of corresponding transmission sections in parallel, respectively;
immediate nodes each having completed the individual optimization sequentially transmits a first signal indicating completion of upstream individual optimization in a downstream direction; and
the most downstream node and the immediate nodes sequentially transmit a second signal indicating completion of entire optimization in an upstream direction.

6. The optical communication system according to claim 5, wherein the most upstream immediate node transmits the first signal when having completed its own individual optimization, wherein each intermediate node but the most upstream immediate node transmits the first signal to a corresponding downstream node when having received the first signal from a corresponding upstream node and having completed its own individual optimization.

7. The optical communication system according to claim 6, wherein each node which has received the second signal from a corresponding downstream node automatically switches from a test mode to an operation mode.

8. The optical communication system according to claim 5, wherein the most downstream node automatically switches from a test mode to an operation mode when having received the first signal from a corresponding upstream node and having completed its own individual optimization, wherein each node but the most downstream node which has received the second signal from a corresponding downstream node automatically switches from the test mode to the operation mode.

9. An optical transmitter in an optical communication system in which an optical signal is sequentially transferred through a plurality of transmission sections of an entire transmission line between the optical transmitter and an optical receiver, wherein the entire transmission line is sectioned by at least one intermediate node into the transmission sections, comprising:
a test signal generator for generating the test signal;
a switch for selectively outputting a main signal and a test signal depending on which one of a test mode and an operation mode is set; and
a transmitter controller for controlling the switch such that when the test mode is set, the switch outputs the test signal which is transmitted to a most upstream immediate node, causing the most stream immediate node to perform individual optimization and transmit a first signal indicating completion of upstream individual optimization in a downstream direction and, when receiving a second signal indicating completion of entire optimization from the most upstream immediate node, the switch outputs the main signal.

10. An optical receiver in an optical communication system in which an optical signal is sequentially transferred through a plurality of transmission sections of an entire transmission line between an optical transmitter and the optical receiver, wherein the entire transmission line is sectioned by at least one intermediate node into the transmission sections, comprising:
an optimization controller for performing individual optimization of a corresponding transmission section connected to a most downstream intermediate node; and
a receiver controller for controlling such that when the individual optimization has been completed and a first signal indicating completion of upstream individual optimization has been received from the most downstream intermediate node in a test mode, a second signal indicating completion of entire optimization is transmitted to the most downstream intermediate node and the test mode is switched to an operation mode.

11. An optical repeater in an optical communication system in which an optical signal is sequentially transferred through a plurality of transmission sections of an entire transmission line between an optical transmitter and an optical receiver, wherein the entire transmission line is sectioned by at least one optical repeater into the transmission sections, comprising:
a test signal generator for generating the test signal;
a switch for selectively outputting a main signal and a test signal depending on which one of a test mode and an operation mode is set;
an optimization controller for performing individual optimization of a corresponding transmission section connected to an adjacent intermediate node or the optical transmitter;
a first controller for controlling such that when the individual optimization has been completed and a first signal indicating completion of upstream individual optimization has been received from the adjacent intermediate node in the test mode, a second signal indicating completion of entire optimization is transmitted to the adjacent intermediate node or the optical receiver; and
a second controller for controlling the switch such that when the first signal has been received from the adjacent intermediate node and the second signal has been received from the adjacent intermediate node, the switch outputs the main signal.

12. An optical communication device comprising an optical transmitter and an optical receiver in an optical communication system in which an optical signal is sequentially transferred through a plurality of transmission sections of an entire transmission line between the optical transmitter and the optical receiver, wherein the entire transmission line is sectioned by at least one intermediate node into the transmission sections, wherein
the optical transmitter comprises:
a test signal generator for generating the test signal;
a switch for selectively outputting a main signal and a test signal depending on which one of a test mode and an operation mode is set; and
a transmitter controller for controlling the switch such that when the test mode is set, the switch outputs the test signal which is transmitted to a most upstream immediate node, causing the most stream immediate node to perform individual optimization and transmit a first signal indicating completion of upstream individual optimization in a downstream direction and, when receiving a second signal indicating completion of entire optimization from the most upstream immediate node, the switch outputs the main signal, and
the optical receiver comprises:
an optimization controller for performing individual optimization of a corresponding transmission section connected to a most downstream intermediate node; and
a receiver controller for controlling such that when the individual optimization has been completed and a first signal indicating completion of upstream individual optimization has been received from the most downstream intermediate node in a test mode, a second signal indicating completion of entire optimization is transmitted to the most downstream intermediate node and the test mode is switched to an operation mode.

13. An optical communication system comprising an optical transmitter, an optical receiver and at least one optical repeater, wherein an optical signal is sequentially transferred through a plurality of transmission sections of an entire transmission line between the optical transmitter and the optical receiver, wherein the entire transmission line is sectioned by at least optical repeater into the transmission sections, wherein
the optical transmitter comprises:
a test signal generator for generating the test signal;
a switch for selectively outputting a main signal and a test signal depending on which one of a test mode and an operation mode is set; and
a transmitter controller for controlling the switch such that when the test mode is set, the switch outputs the test signal which is transmitted to a most upstream immediate node, causing the most stream immediate node to perform individual optimization and transmit a first signal indicating completion of upstream individual optimization in a downstream direction and, when receiving a second signal indicating completion of entire optimization from the most upstream immediate node, the switch outputs the main signal,
the optical receiver comprises:
an optimization controller for performing individual optimization of a corresponding transmission section connected to a most downstream intermediate node; and
a receiver controller for controlling such that when the individual optimization has been completed and a first signal indicating completion of upstream individual optimization has been received from the most downstream intermediate node in a test mode, a second signal indicating completion of entire optimization is transmitted to the most downstream intermediate node and the test mode is switched to an operation mode, and
each optical repeater comprises:
a repeater test signal generator for generating the test signal;
a repeater switch for selectively outputting a main signal and a test signal depending on which one of a test mode and an operation mode is set;
a repeater optimization controller for performing individual optimization of a corresponding transmission section connected to an adjacent intermediate node or the optical transmitter;
a first controller for controlling such that when the individual optimization has been completed and a first signal indicating completion of upstream individual optimization has been received from the adjacent intermediate node in the test mode, a second signal indicating completion of entire optimization is transmitted to the adjacent intermediate node or the optical receiver; and
a second controller for controlling the switch such that when the first signal has been received from the adjacent intermediate node and the second signal has been received from the adjacent intermediate node, the switch outputs the main signal.

14. A computer-readable medium storing a program for instructing a computer to perform transmission line optimization in an optical transmitter in an optical communication system in which an optical signal is sequentially transferred through a plurality of transmission sections of an entire transmission line between the optical transmitter and an optical receiver, wherein the entire transmission line is sectioned by at least one intermediate node into the transmission sections, comprising:
generating the test signal;
selectively outputting a main signal and a test signal depending on which one of a test mode and an operation mode is set; and
when the test mode is set, selecting the test signal to transmit it to a most upstream immediate node, causing the most stream immediate node to perform individual optimization and transmit a first signal indicating completion of upstream individual optimization in a downstream direction and, when receiving a second signal indicating completion of entire optimization from the most upstream immediate node, selecting the main signal.

15. A computer-readable medium storing a program for instructing a computer to perform transmission line optimization in an optical receiver in an optical communication system in which an optical signal is sequentially transferred through a plurality of transmission sections of an entire transmission line between the optical transmitter and an optical receiver, wherein the entire transmission line is sectioned by at least one intermediate node into the transmission sections, comprising:
performing individual optimization of a corresponding transmission section connected to a most downstream intermediate node; and
when the individual optimization has been completed and a first signal indicating completion of upstream individual optimization has been received from the most downstream intermediate node in a test mode, transmitting a second signal indicating completion of entire optimization to the most downstream intermediate node and switching the test mode to an operation mode.

16. A computer-readable medium storing a program for instructing a computer to perform transmission line optimization in an optical repeater in an optical communication system in which an optical signal is sequentially transferred through a plurality of transmission sections of an entire transmission line between an optical transmitter and an optical receiver, wherein the entire transmission line is sectioned by at least one optical repeater into the transmission sections, comprising:
generating the test signal;
selectively outputting a main signal and a test signal depending on which one of a test mode and an operation mode is set; and
performing individual optimization of a corresponding transmission section connected to an adjacent intermediate node or the optical transmitter;
when the individual optimization has been completed and a first signal indicating completion of upstream individual optimization has been received from the adjacent intermediate node in the test mode, transmitting a second signal indicating completion of entire optimization to the adjacent intermediate node or the optical receiver; and
when the first signal has been received from the adjacent intermediate node and the second signal has been received from the adjacent intermediate node, switching an output signal from the test signal to the main signal.
